(19) United States
(12) Patent Application Publication
(10) Pub. No.: US 2002/0178043 A1
(43) Pub. Date: Nov. 28, 2002

(54) Method and system for monitoring employee availability

(76) Inventor: J. Brian Searles, Englewood, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/865,894

(22) Filed: May 25, 2001

(51) Int. Cl. G06F 17/60

(52) U.S. Cl. 705/8

(57) ABSTRACT

A method and system for monitoring availability of a plurality of units is provided. A list is maintained identifying the plurality of units, including a notation to indicate whether each unit is unavailable. An electronic identification of a particular one of the units is accepted, from which it is determined whether the list includes the notation that the particular unit is unavailable. If it does include that notation, the list is automatically modified to remove the notation. If it does not include the notation, information is collected to specify unavailability of the particular unit.

### BACKGROUND OF THE INVENTION

The present invention relates generally to a method and system for monitoring the availability of units. More particularly, the invention relates to a method and system for monitoring employee availability.

The nature of many modern businesses is such that individuals can be difficult to contact. People that a person wishes to contact are often not available at their desks. Such absences may be short, such as those created by routine events—attendance at meetings both within and outside the office, lunch engagements, illness, or even a desire by an individual to be unavailable for a certain period of time to attend to issues without interruption. Sometimes absences are more extensive, such as those resulting from business travel, from vacation, or from maternity leave, among other reasons.

While messaging systems such as voicemail can be useful under some circumstances, frequently a person would prefer not to make a telephone call if he knows that an individual is not presently available to receive such a call. This is often particularly the case internally within a business where the value of many types of telephone consultations depends on their immediacy. The decrease in efficiency when individuals are unavailable for such consultations may be ever greater where a business is spread over multiple offices so that informal monitoring of one's availability is even more difficult. For callers external to a business, the efficiency of a receptionist is enhanced when (s)he is aware of current availability within an office so that an appropriate response can be provided immediately to a caller.

Examples of past attempts to provide receptionists and others within an office with availability information include the circulation of printed schedules for individuals or the circulation of printed calendars showing scheduled absences. More recently, such schedules and calendars have sometimes been posted on an internal network, but they still suffer from the fact that they are completely static documents that do not account for deviations from a predetermined schedule. Other past attempts to provide availability information have included lists, typically placed near a business's reception area, where individuals would sign in and out. While such information is of some use, it makes no account of the ongoing variations in availability that affect people throughout the day.

There is accordingly a need for a method and system that provides real-time information about the availability of individuals, both on short-term and on long-term bases. Such a system should be especially easy to use so that its administration does not by itself act to interfere with the efficiency it is intended to promote.

### SUMMARY OF THE INVENTION

Thus, embodiments of the invention are directed to a method and system for monitoring availability of a plurality of units. A list is maintained identifying the plurality of units, including a notation to indicate whether each unit is unavailable. An electronic identification of a particular one of the units is accepted, from which it is determined whether the list includes the notation that the particular unit is unavailable. If it does include that notation, the list is automatically modified to remove the notation. If it does not include the notation, information is collected to specify unavailability of the particular unit. In one embodiment, the list is modified to indicate the particular unit is unavailable in accordance with the collected information. The units whose availability is monitored may be, for example, stations or persons, such as employees within a business organization.

In one embodiment, the list is displayed. The displayed list may include descriptive headings in a language selected by a user. In one embodiment, only a portion of the list is displayed, with every unit in the displayed portion including an unavailability notation.

In a certain embodiment, two lists are maintained, one listing periods of unavailability less than a day and one listing periods of unavailability longer than a day. The lists may be correlated by unit by including a notation on the first list to indicate that unavailability information for that unit exists on the second list.

In other embodiments, a computer-readable storage medium is provided to monitor availability of a plurality of units according to the description above. In further embodiments, a computer system is provided with a processor configured to execute instructions in accordance with the above description. In one embodiment, the processor is in communication with a plurality of input devices and a plurality of display devices. The processor may be configured for such communication, for example, through a network or through the internet.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follow a hyphen to denote one of multiple similar components. When reference is made to a reference numeral without specification to an existing sublabel, it is intended to refer to all such multiple similar components.

FIG. 1 is a schematic illustration of an embodiment of the invention that makes use of the internet for networking the system;

FIGS. 2A and 2B are screen shots illustrating one embodiment of the short-absence register;

FIG. 2C is a flow diagram illustrating operation of one embodiment of the short-absence register;

FIG. 3 is a screen shot illustrating one embodiment of the long-absence register;

FIG. 4A is a flow diagram illustrating the overall operation of one embodiment of the system;

FIGS. 4B-4D are screen shots illustrating the overall operation of one embodiment of the system;

FIG. 5A is a flow diagram illustrating one embodiment of the operation of the short-absence register;

FIGS. 5B-5D are screen shots illustrating the operation of one embodiment of the short-absence register;

FIG. 6A is a flow diagram illustrating one embodiment of the operation of the long-absence register;

FIGS. 6B and 6C are screen shots illustrating the operation of one embodiment of the long-absence register; and

FIGS. 7A-7E are screen shots illustrating system administration of one embodiment of the invention.

### DETAILED DESCRIPTION OF THE INVENTION

A real-time easy-to-use system is provided for monitoring the availability of people or stations. As used herein, the term “unit” is used to refer collectively to people or stations. One example of an embodiment for monitoring the availability of people is a system for monitoring employee availability within an organization. An example of an embodiment for monitoring station availability is provided by the office of a medical doctor in which patients are assigned to multiple examination rooms. Other applications of the system will be evident to those of skill in the art after reading the following description.

The method and system are configured to treat two types of unavailability, short-term and long-term. Such states of unavailability are sometimes referred to herein as “absences,” both for embodiments directed to monitoring the availability of people and for embodiments directed to monitoring the availability of stations. In the particular embodiment where employee availability is monitored, short-term absences are those that generally last a day or less. Examples of short-term absences include those resulting from meetings, lunch engagements, and others. Long-term absences are those that generally last longer than a day, examples for which include vacations, extended business trips, and family leaves.

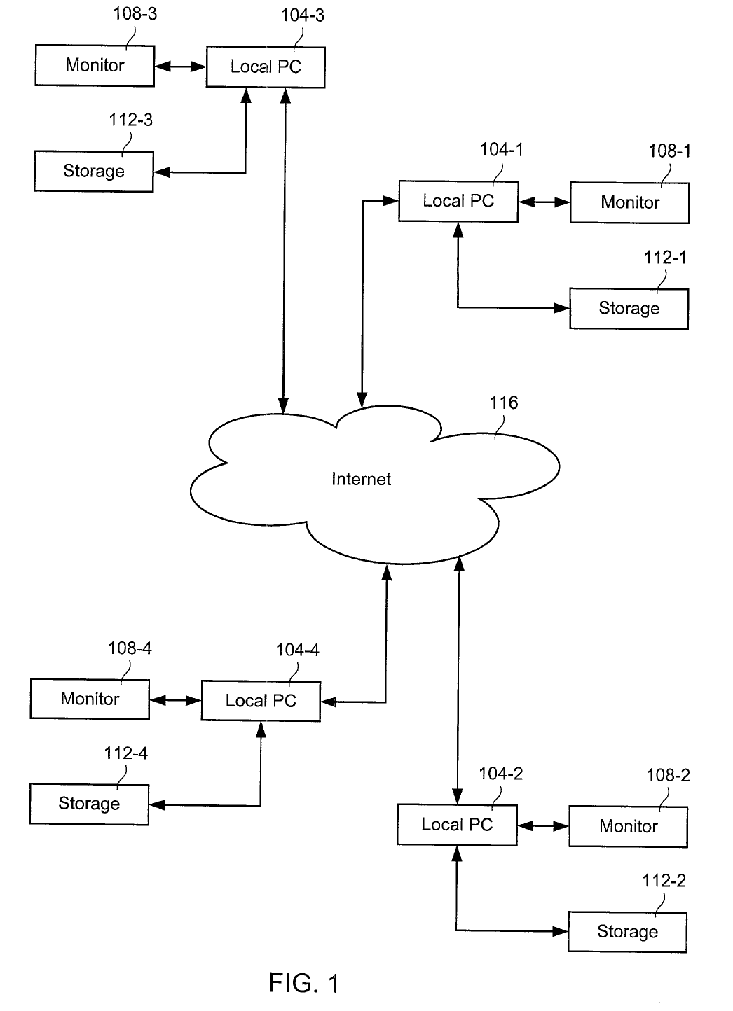

Embodiments of the method and system are adapted for use on a computational device, such as a personal computer (“PC”). In one embodiment, the system is configured purely locally, such as may be appropriate for a business having a single office. In other embodiments, such as that shown schematically in FIG. 1, the system is configured for interaction over multiple locations, with network connections being provided, for example, by the internet 116. In FIG. 1, four PC's 104 are shown connected through the internet 116, each PC being configured with a monitor 108 and a storage device 112. Software configured to perform an embodiment of the method may reside on a single PC 104, with relevant data being stored on the storage device 112. Information used by the system to monitor availability may be accessed by other PC's for display on their monitors 108 through the internet 116. Similarly, data may be provided by those other PC's through the internet 116 to provide real-time availability information to be incorporated in the system.

Embodiments that use a more local configuration may substitute the internet 116 in FIG. 1 with a network such as a local-area network (“LAN”) or a wide-area network (“WAN”), depending on the application. In some embodiments, particularly for certain applications directed at monitoring station availability, no network is used so that all information is entered, managed, and displayed from a single PC.

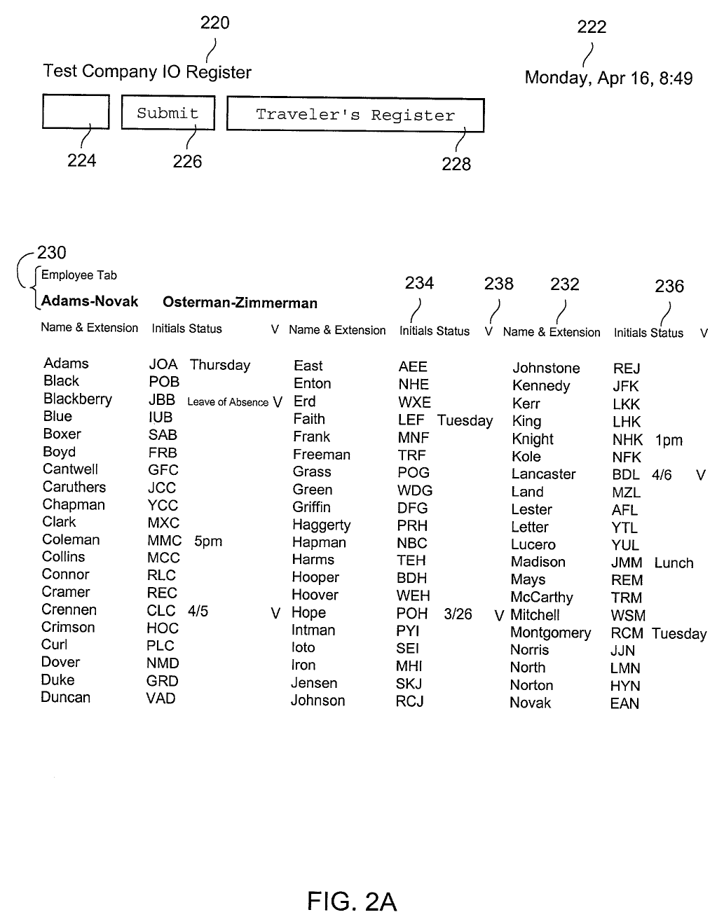

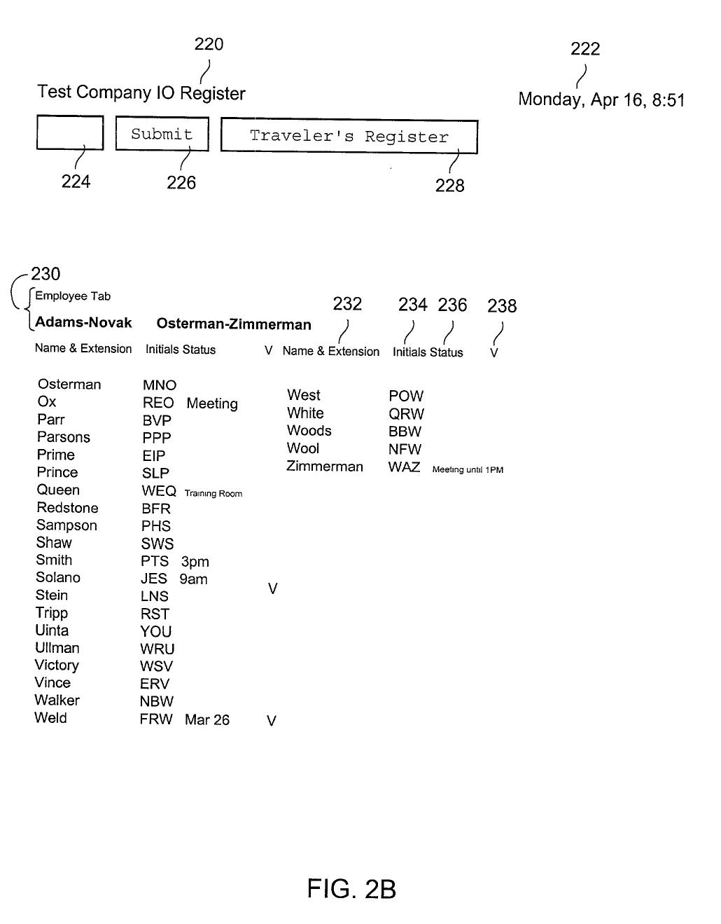

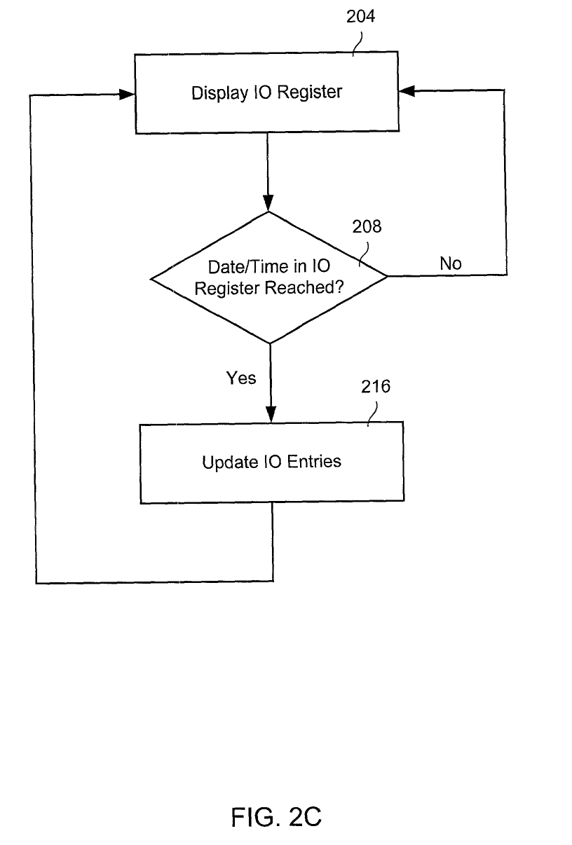

FIGS. 2A-2C illustrate generally the display and maintenance of the shortterm-absence register, referred to as the “IO Register” in the illustrated embodiment. A number of aspects of the system may be understood with reference to FIGS. 2A and 2B, which show a typical display of availability information. In this illustration, the system is configured for monitoring employee availability for a fictitious organization called “Test Company,” identified as such in the header 220. The current date and time are displayed in date field 222. Availability information for a plurality of employees is provided in column format. In the illustrated embodiment, employees are identified by surname and/or telephone extension in identification field 232. Each employee is assigned a three-character code that may conveniently be used, as explained below, to interact with the system efficiently. In the illustrated embodiment, the three-character code corresponds to each employee's initials and is identified in the initials field 234.

For each employee, the status field 236 indicates unavailability information with text. As explained below, such text may be added automatically by the system or may be input in free-field format. A blank entry indicates that no unavailability information exists for the employee. Availability may alternatively be designated affirmatively, such as by using a default-entry of “In” or similar, rather than using a blank default. The final field, referred to herein as the long-term-absence field 238, is denoted by “V” and simply includes a designation that correlates entries in the short-term-absence register with information from the long-term-absence register. When an employee is identified with a “V” in this field 238, it indicates that the employee is unavailable due to a long-term absence and that further information regarding such long-term absence may be obtained from the long-term-absence register. Where the number of units being monitored is large, the display may cover multiple pages. In the illustrated embodiment, an employee tab 230 is provided for access to one of two pages of information; the first page (“Adams”-“Novak”) is shown in FIG. 2A and the second page (“Osterman”-“Zimmerman”) is shown in FIG. 2B. 5

The availability information from FIGS. 2A and 2B may be used internally within an organization. For example, if an individual needs information that he knows can be provided by Mr. Lucero or by Ms Madison, either of whom may reside in offices in different cities, a quick glance at the display indicates that Ms Madison is at lunch, but Mr. Lucero is available. Accordingly, a call may be placed immediately to Mr. Lucero or the individual may decide to wait and call Ms Madison when she returns from lunch. In neither case does he waste time calling someone when unavailable.

The displayed information may be of particular use to the organization's receptionist. When an outside call is received, the receptionist may immediately provide the caller with information regarding the desired party's availability or may connect the caller.

For example, suppose a call is received requesting Ms Knight, who will remain unavailable until 1:00 p.m. Rather than fruitlessly attempting a connection with Ms Knight, paging her, etc. in an attempt to locate her or even to determine whether she is in the office that day, the receptionist may avoid wasting both her time and the caller's time by consulting the short-term-absence register. Then, she may immediately inform the caller that while Ms Knight is in the office today, she does not expect to be available until 1 PM. This improves the efficiency of the receptionist's tasks as well as providing improved interaction with callers. FIG. 2C is a flow diagram showing an update feature that may be included as part of the system in one embodiment. At step 204, the 10 register is displayed. The system periodically monitors the passage of time at step 208 so that the entries may be updated at step 216. Thus, for example, when Mr. Faith returns to the office on Tuesday, the entry indicating that he is unavailable is automatically removed. In an alternative embodiment, this automatic-update feature is not included. Instead, the notification of unavailability is only removed by actively signing into the system. Such an embodiment may be appropriate, for example, to account for the fact that an individual's plans may change and (s)he may not return to the office when originally expected. For example, in this embodiment, if Mr. Faith is unable to return to the office until Wednesday because of some unforeseen circumstance, the system will continue to show him to be unavailable. Accessing the system thereby provides as much useful information as possible—that Mr. Faith expected to return to the office on Tuesday, but has not in fact yet returned.

FIGS. 2A and 2B also show an entry field 224, the function of which is described below, as well as a “Submit” button 226 to submit the information entered in the entry field and a “Traveler's Register” button 228 to switch to the long-term-absence register. The long-term absence register may alternatively be accessed by entering “V” in the entry field 224 and activating the “Submit” button 226.

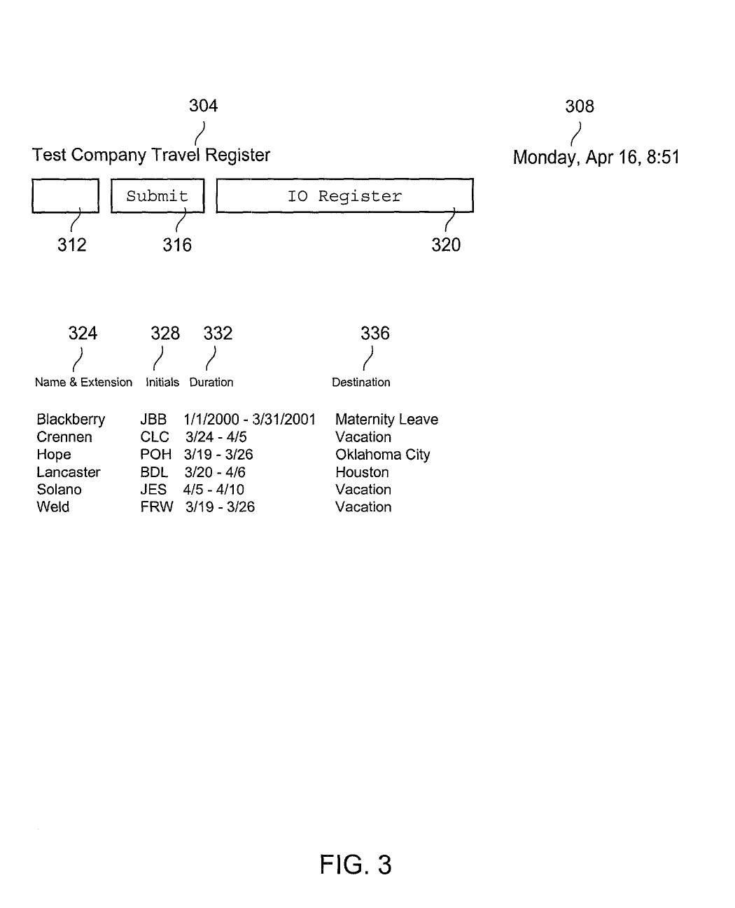

The long-term-absence register is shown in FIG. 3, referred to in the illustrated embodiment as the “Traveler's Register,” with a header 304 and a date field 308. As for the short-term-absence register, information is presented in a column format, identifying employees with their names and/or extension numbers in identification field 324 and by their initials in initials field 328. In the illustrated embodiment, only those employees who are currently unavailable are displayed in the long-term-absence register. The duration of the long-term absence is indicated in the duration field 332 by showing beginning and end dates for the absence, and the employee's destination during the absence is indicated in the absence field 336. An entry field 312 is provided with a “Submit” button 316 to submit information, as is an “IO Register” button 320 to switch back to the short-term-absence register.

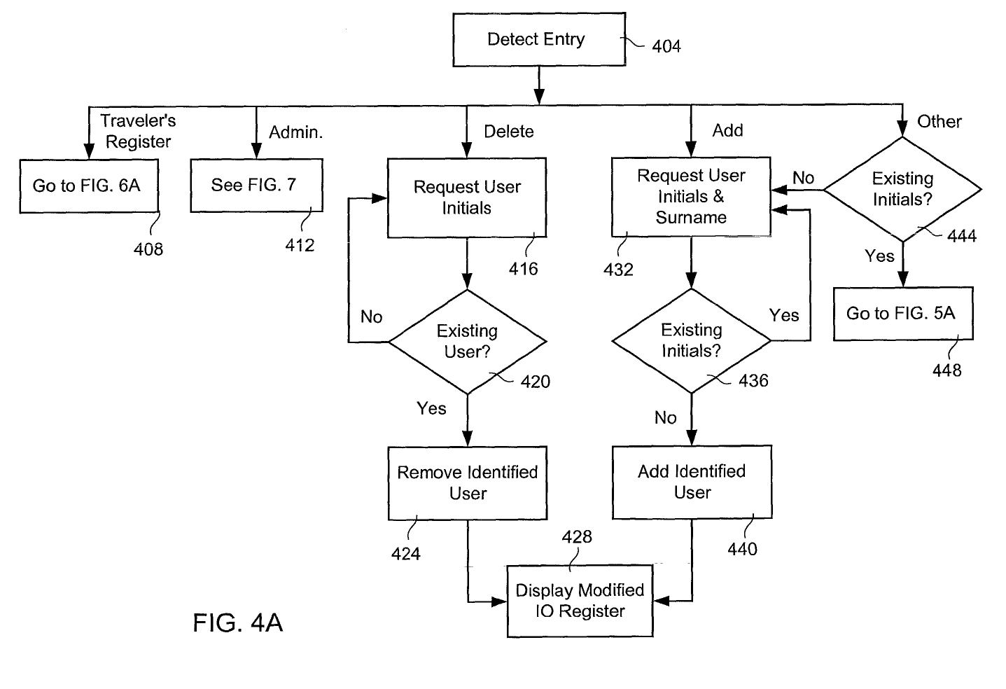

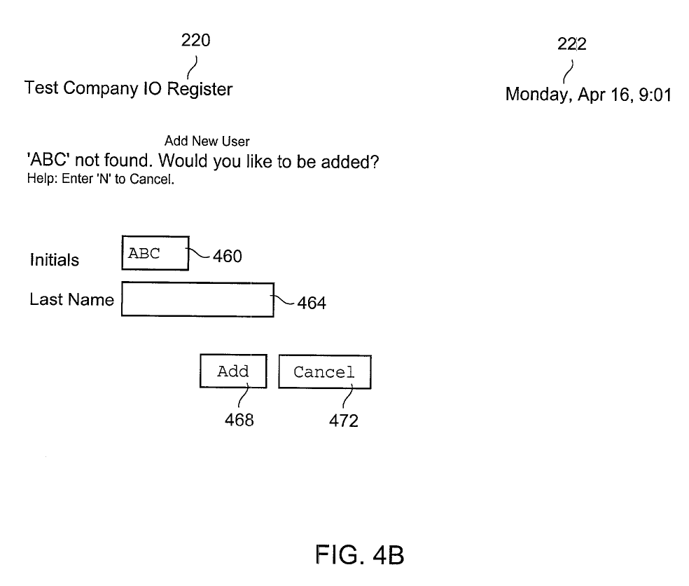

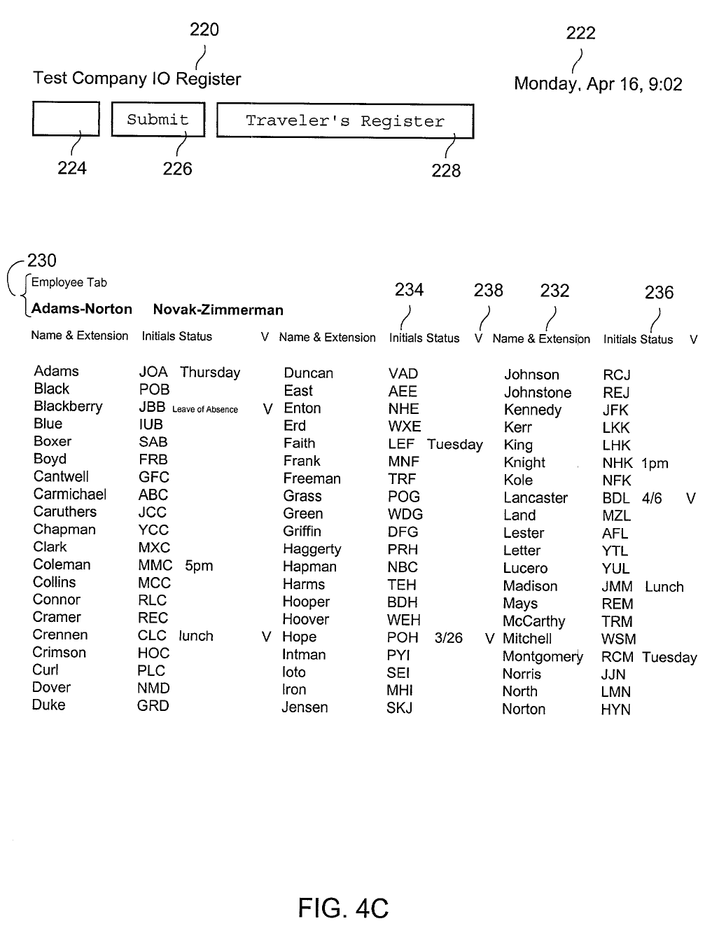

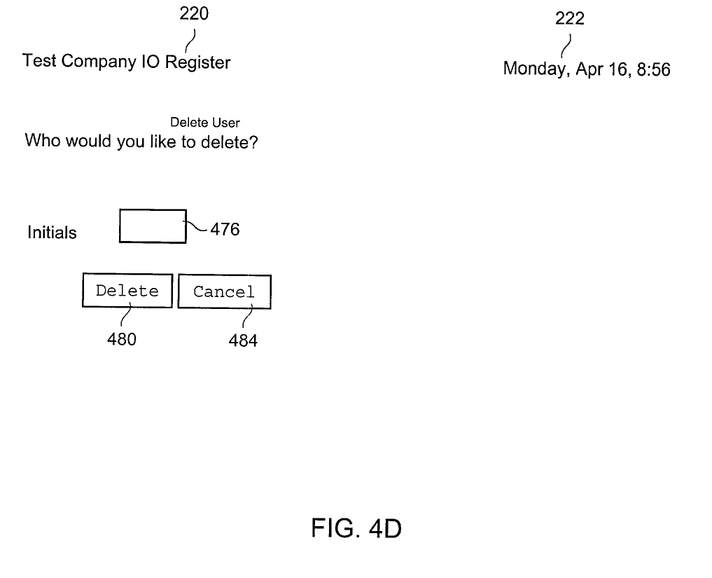

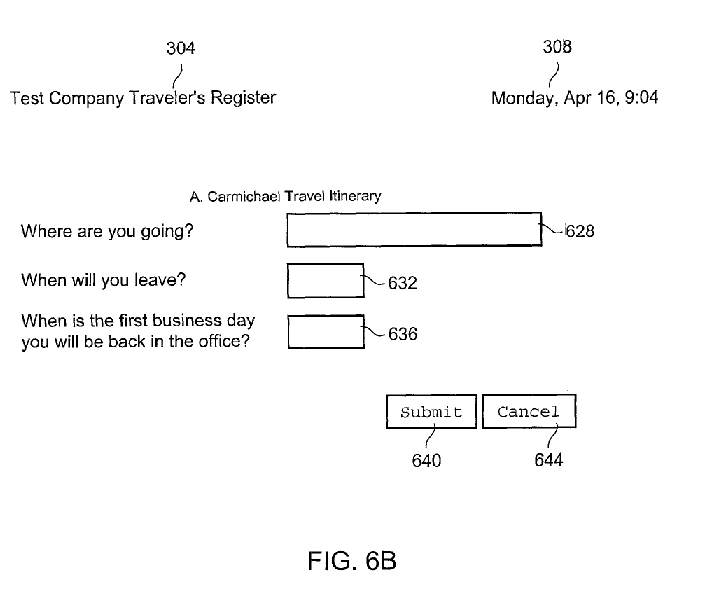

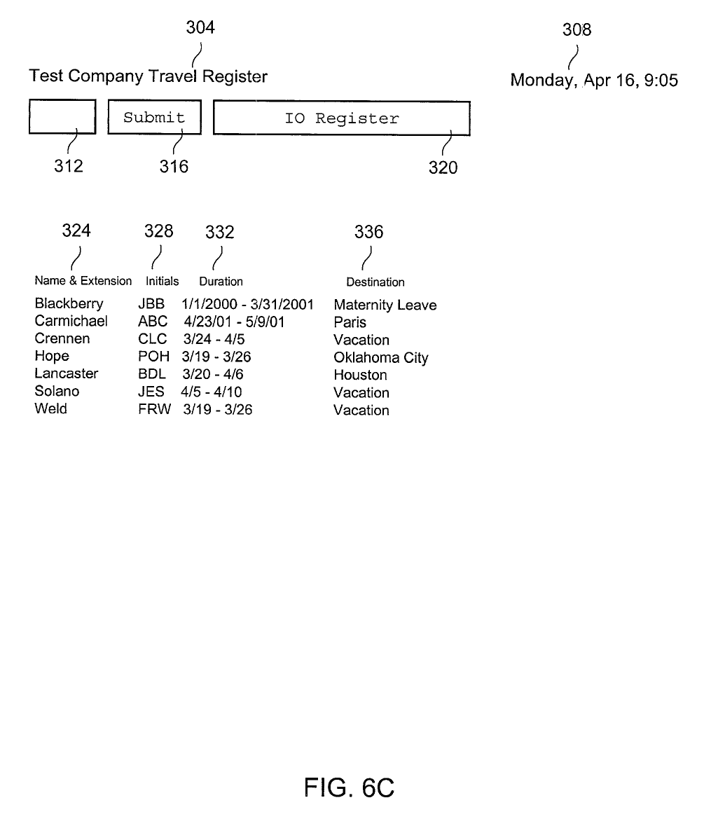

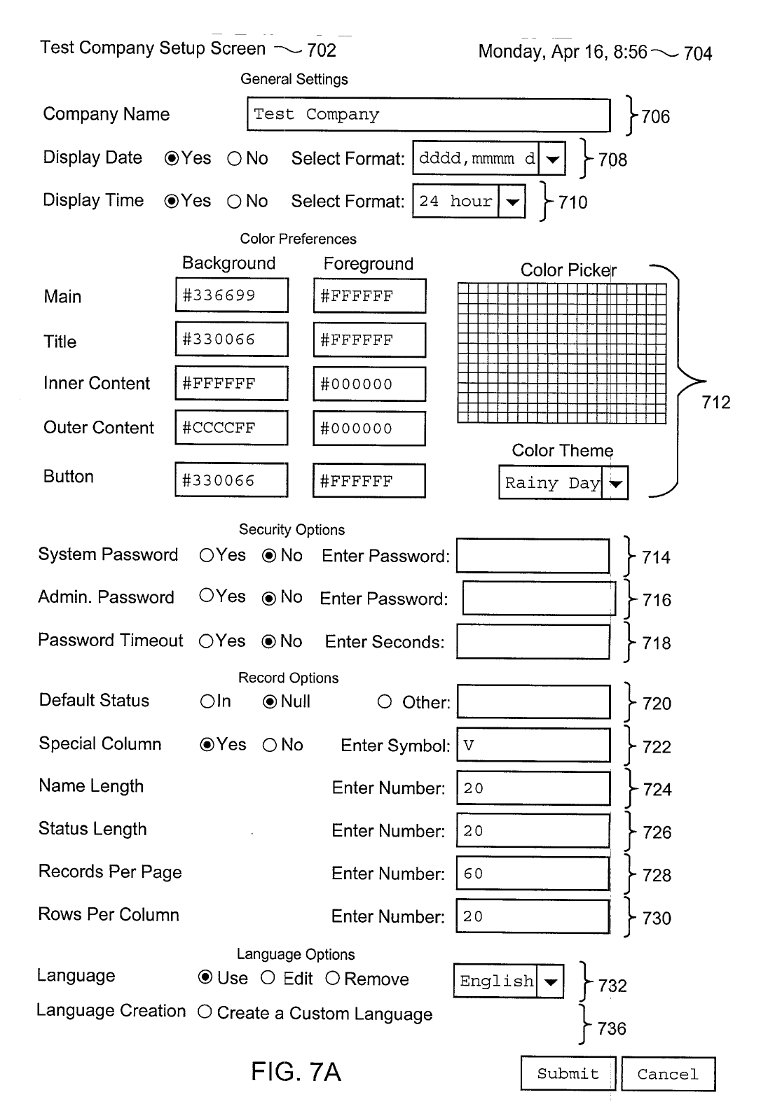

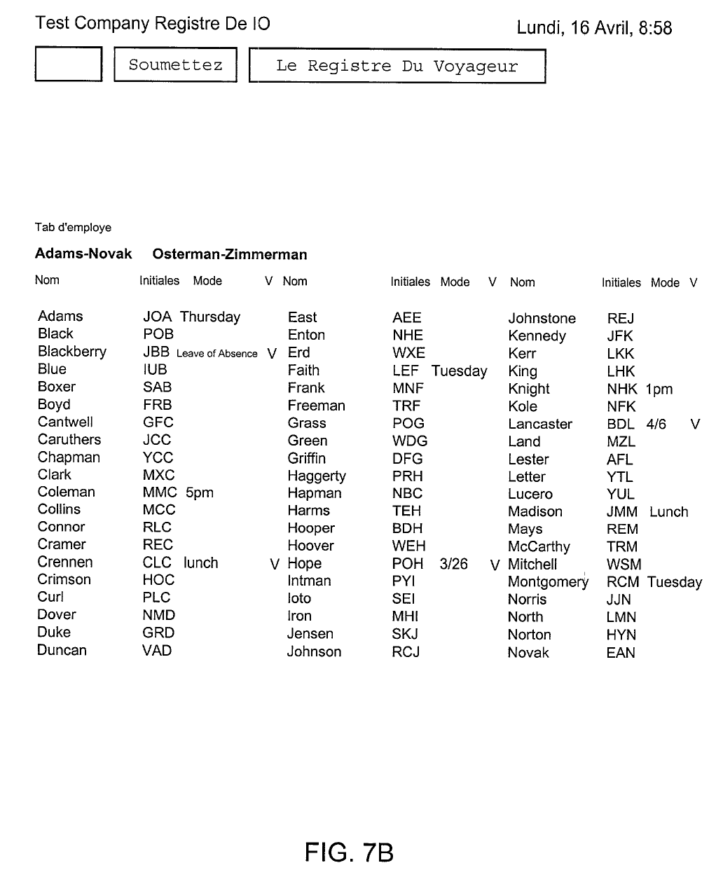

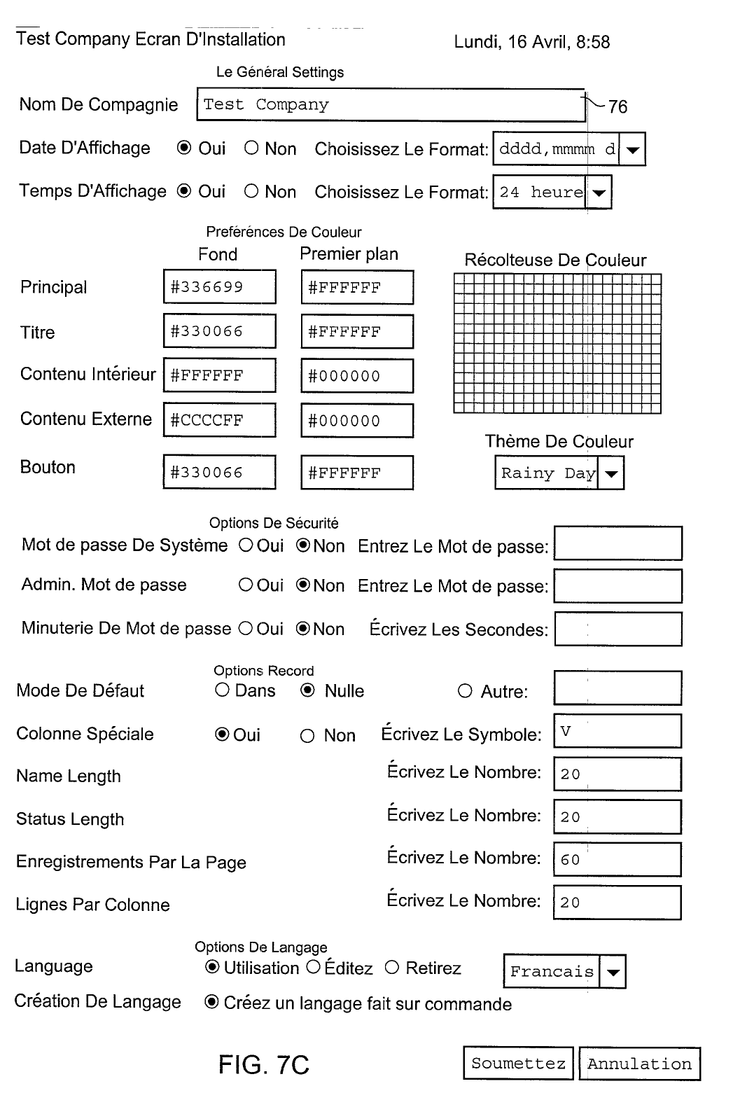

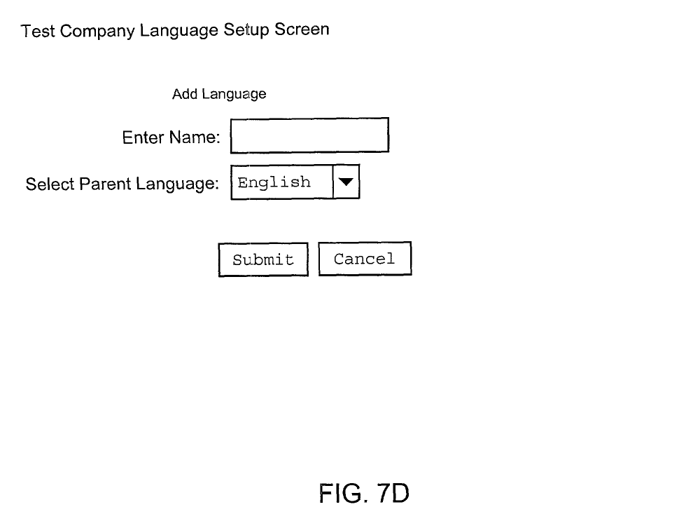

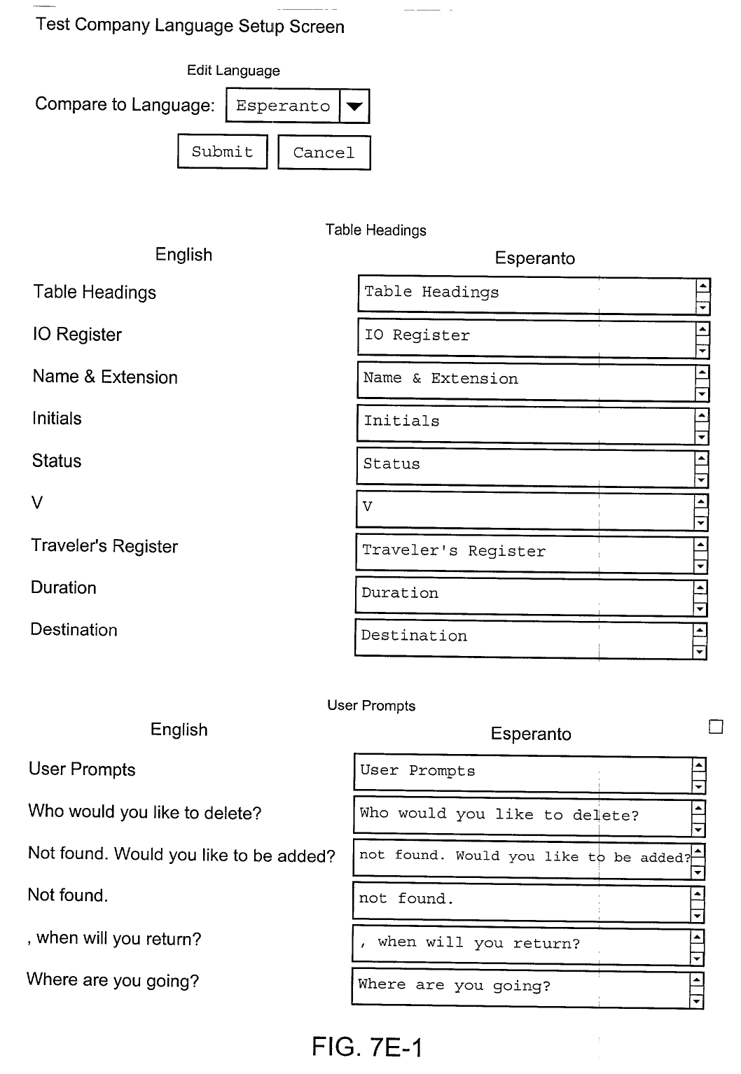

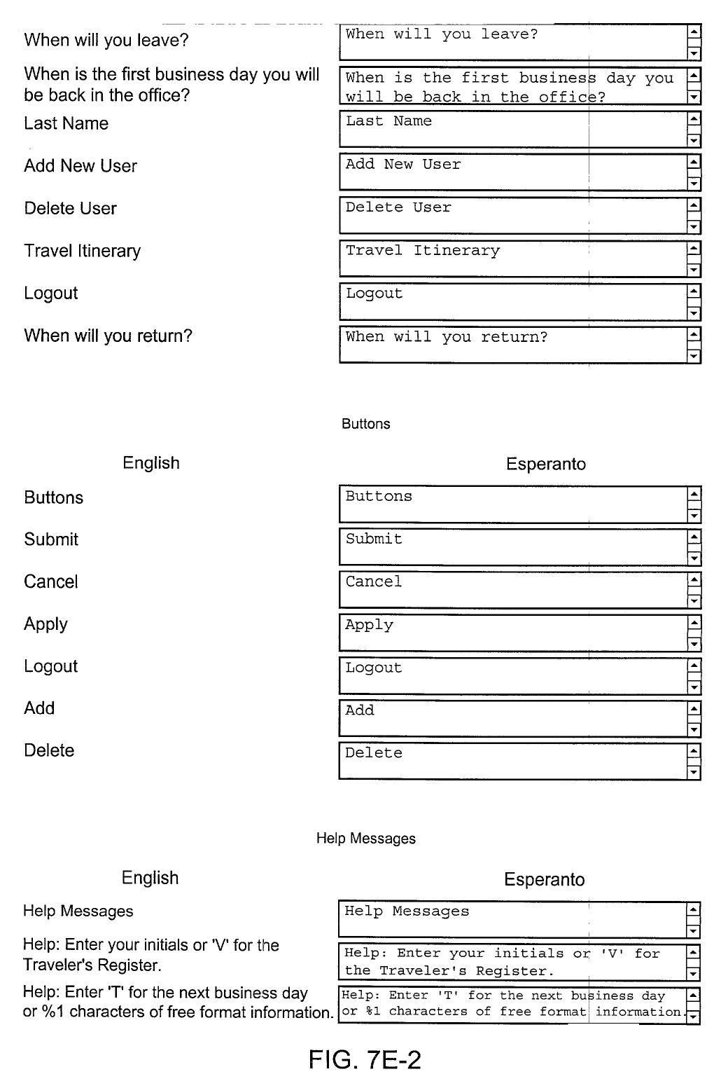

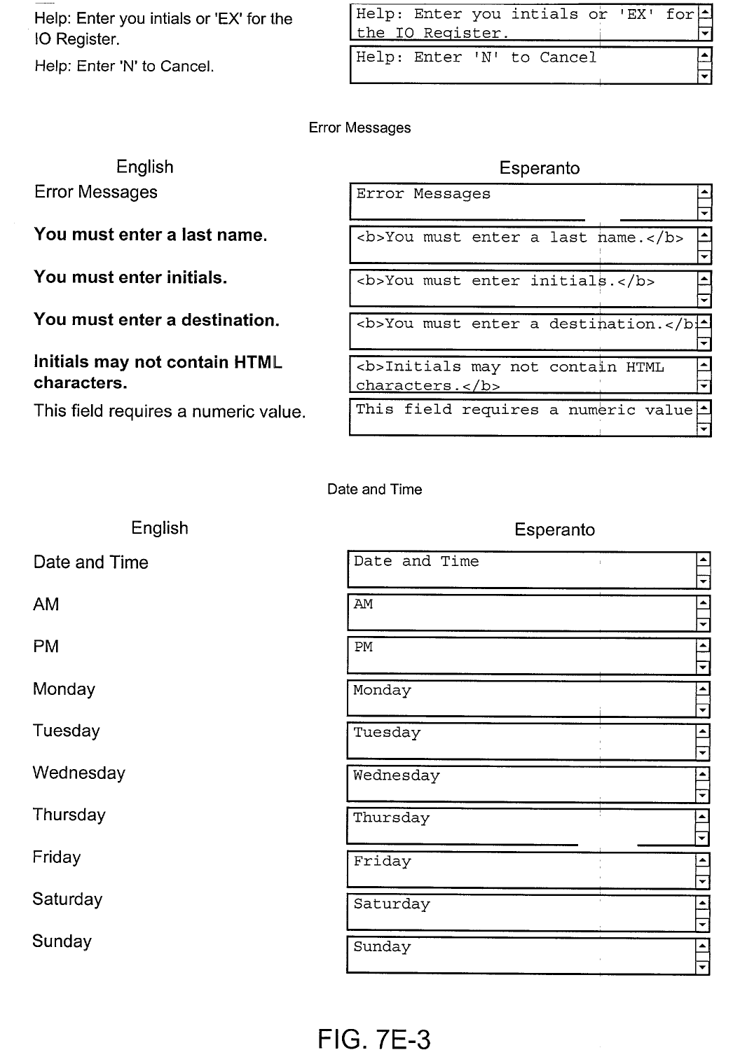

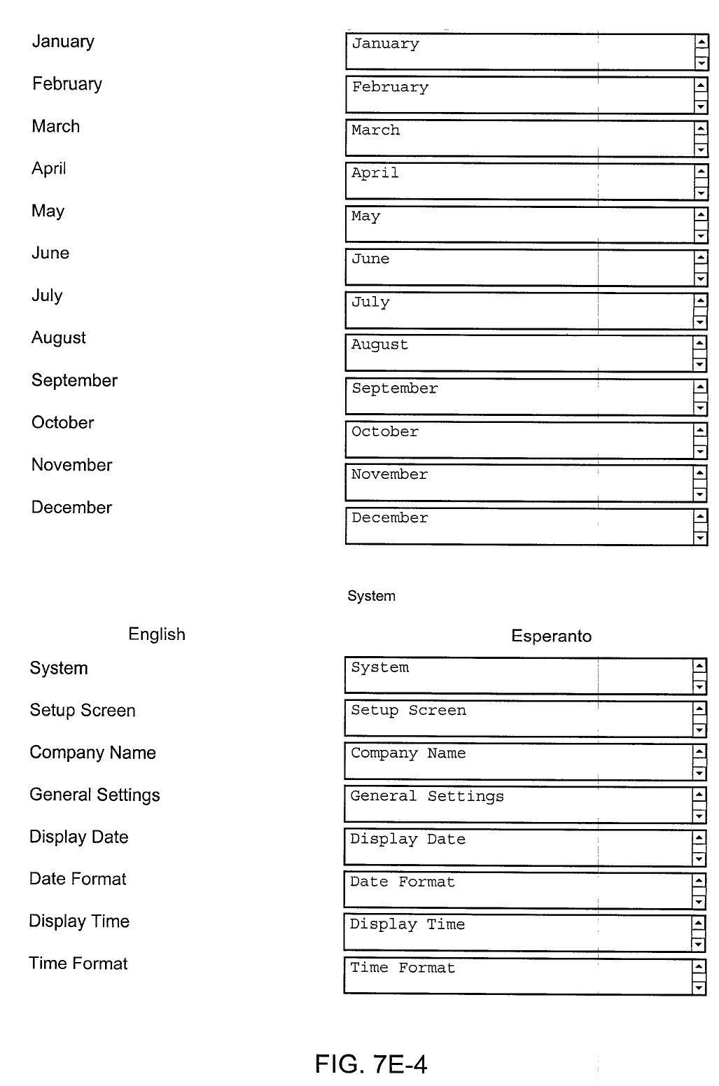

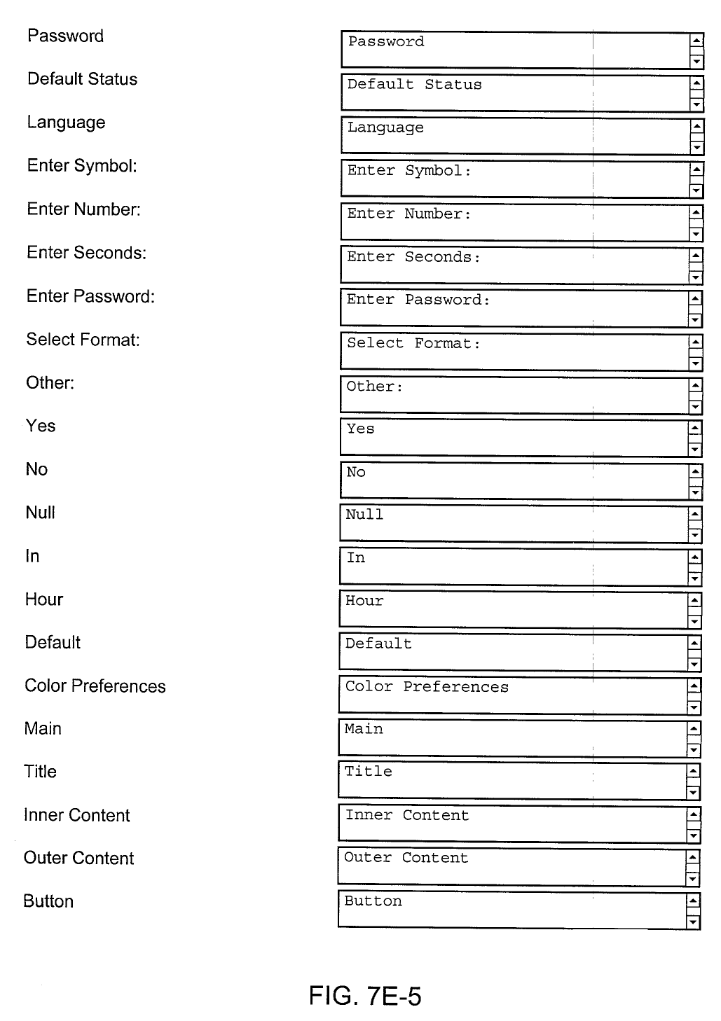

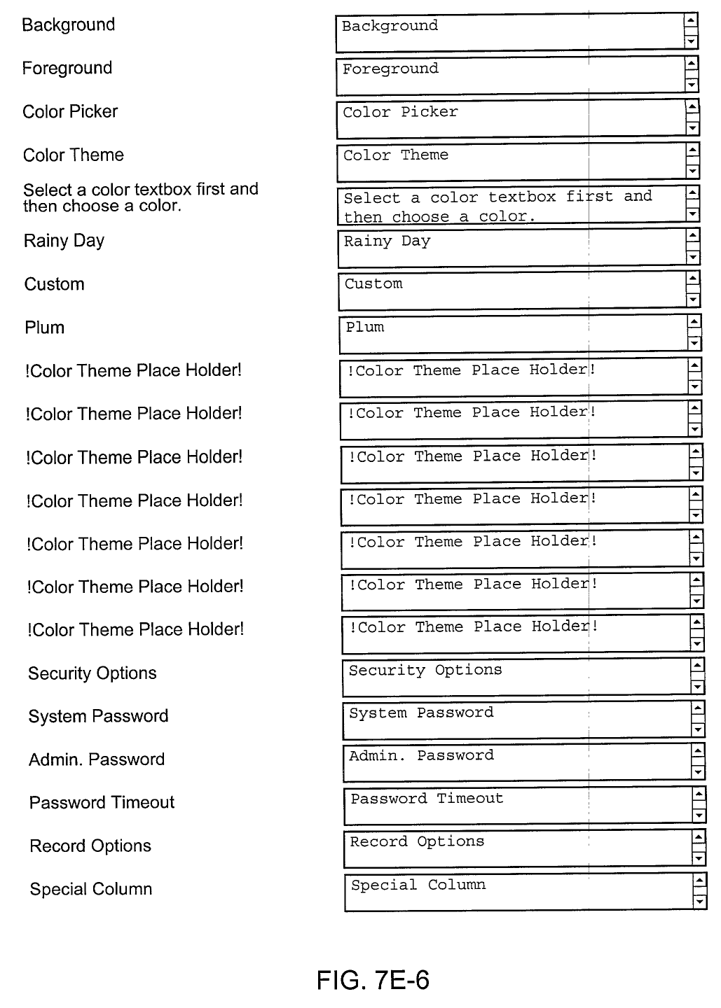

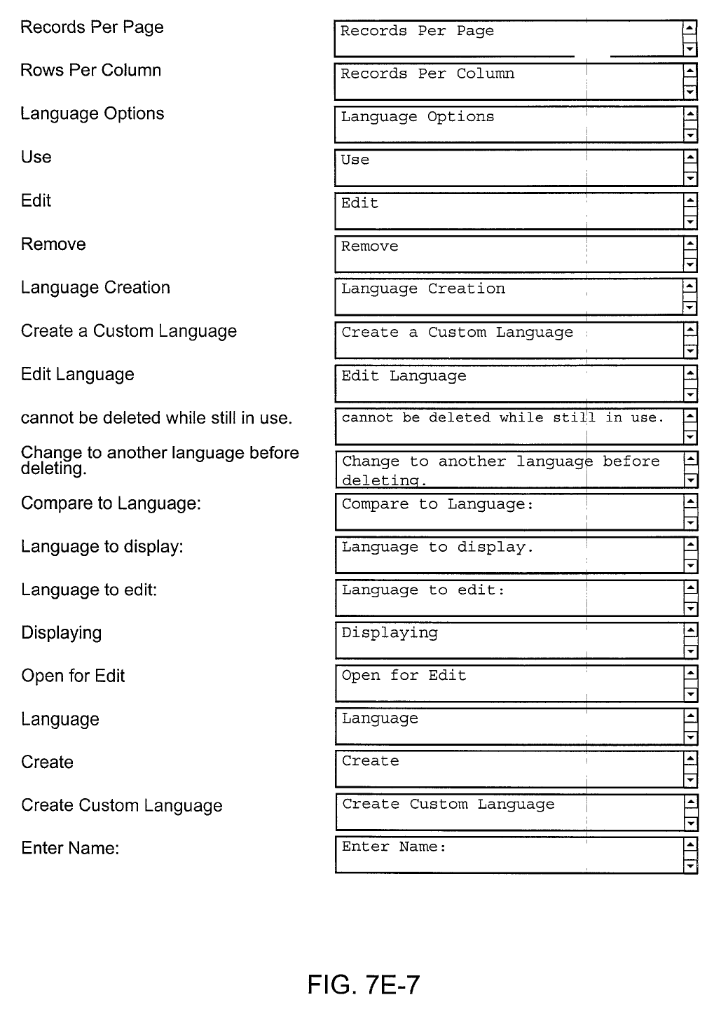

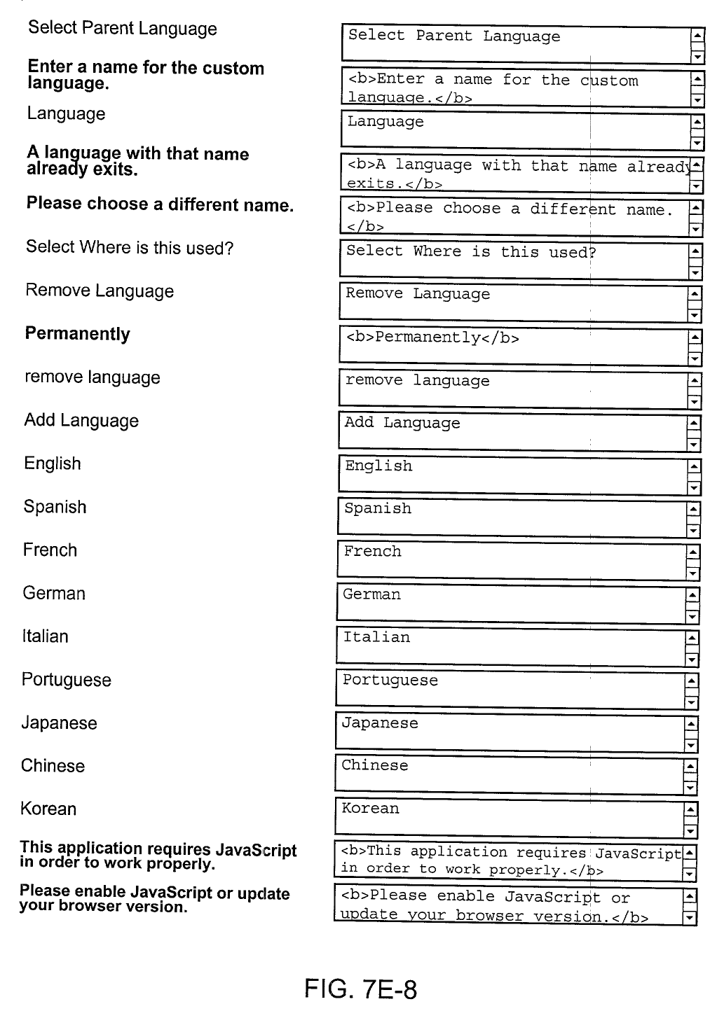

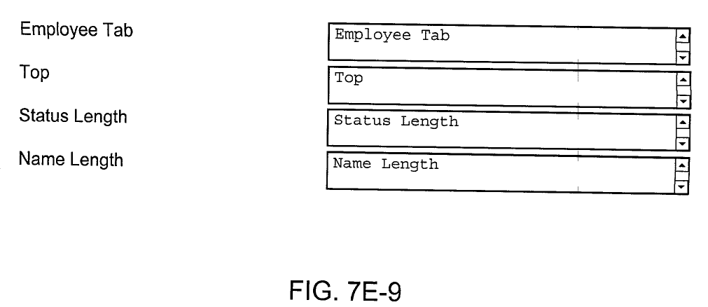

The overall operation of the system from the short-term register is illustrated in FIG. 4A. From the short-term register, such as shown in FIG. 2A, an entry is made into the entry field 224 and detected at step 404 upon activation of the “Submit” button 226. The system generally contemplates that a single character will be entered to access other aspects of the system or that an employee's initials, typically of two or three characters, will be entered. Thus, for example, if the letter “V” is entered, the long-term-absence Traveler's Register is to be accessed at step 408, described below with reference to FIG. 6. If the letter “A” is entered, certain administration features of the system, described below with reference to FIG. 7, are accessed at step 412.

The character “D” may be used to delete an employee from the system, such as may be used when that individual's employment with the organization ends. Upon recognition of the delete character at step 416, a screen is presented, such as shown in FIG. 4D, requesting identification of the user to be deleted. The delete screen of FIG. 4D includes a field 476 for entering the initials of the employee to be deleted, as well as a “Delete” button 480 to execute the deletion and a “Cancel” button 484 to cancel the deletion. After entry of the user initials, the system performs a check at step 420 to ensure that an existing employee's initials have been entered. If not, the prompt requesting entry of the employee's initials is repeated. If so, the identified user is removed from the system records at step 424 and the system returns to display of the modified short-term-absence register at step 428.

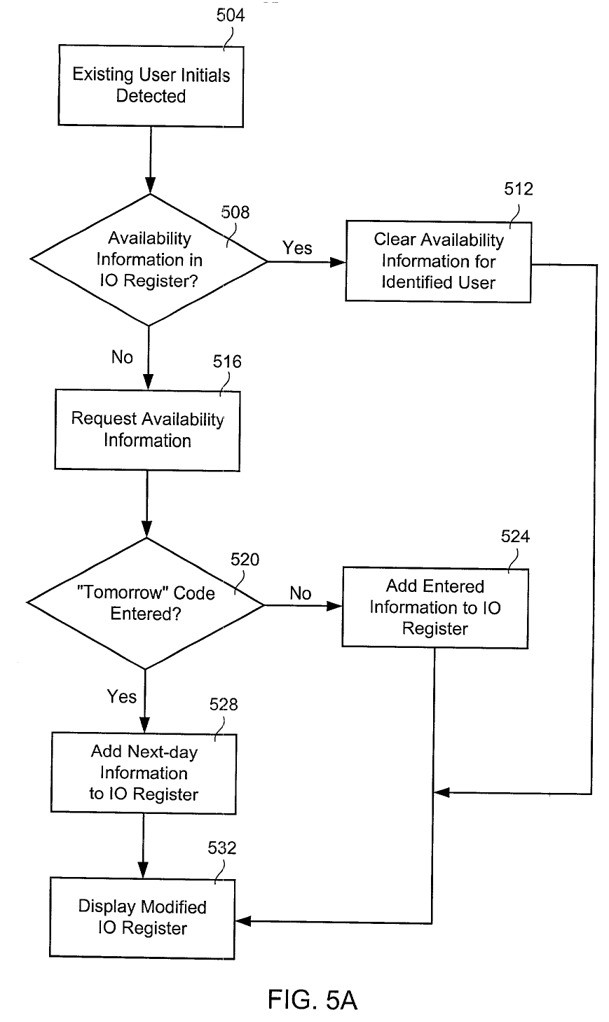

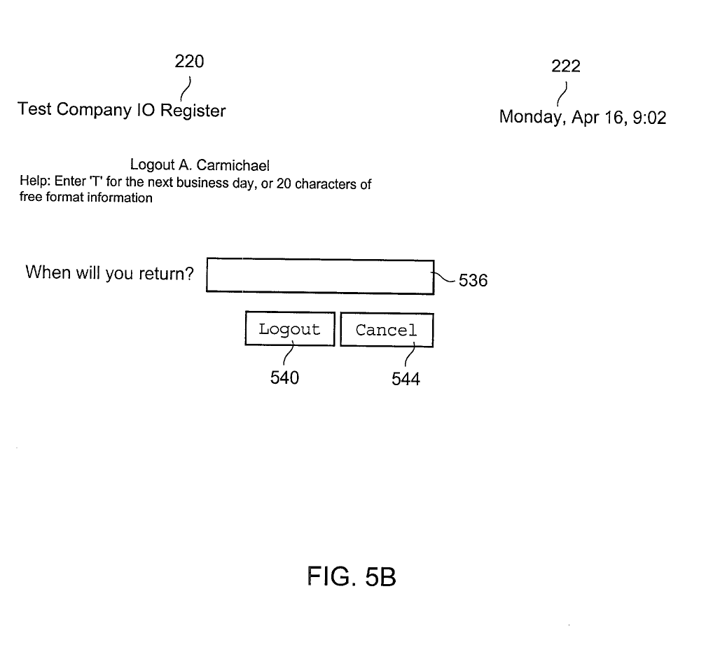

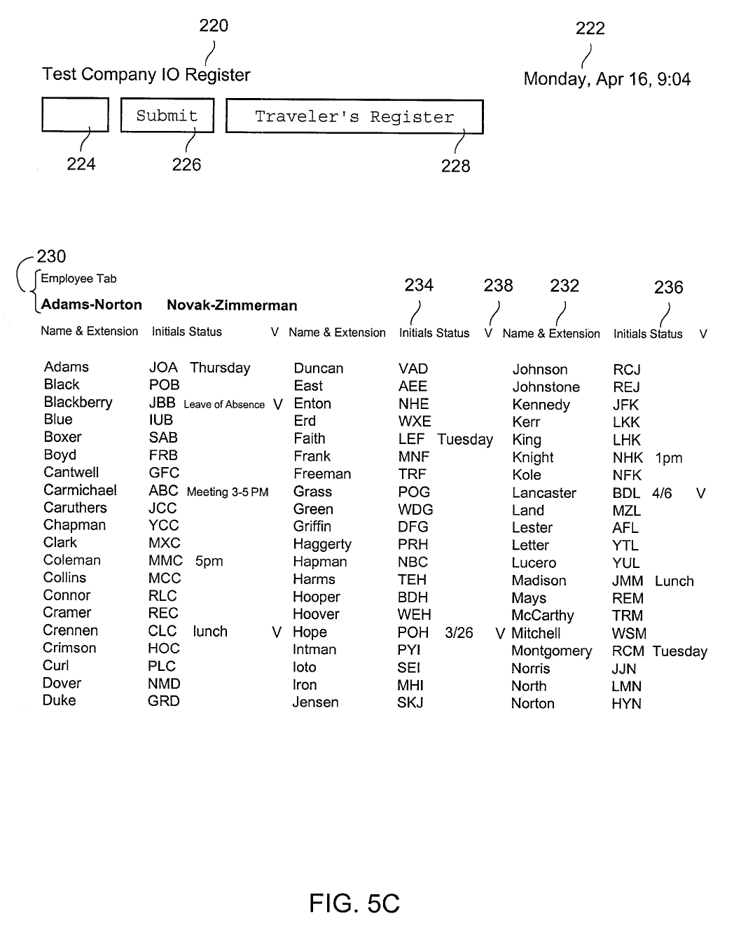

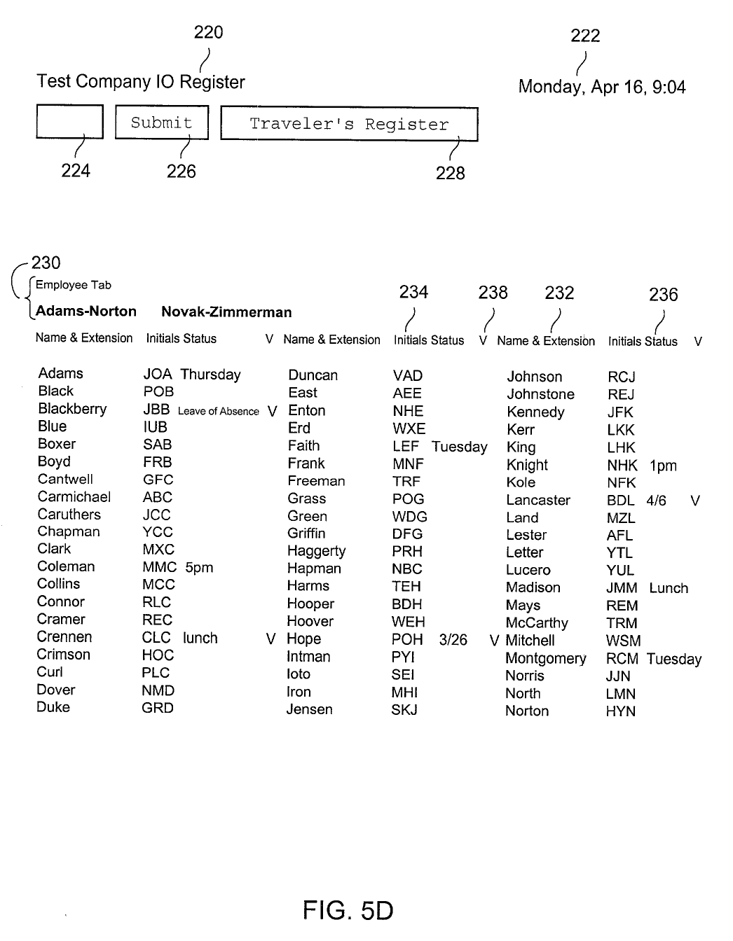

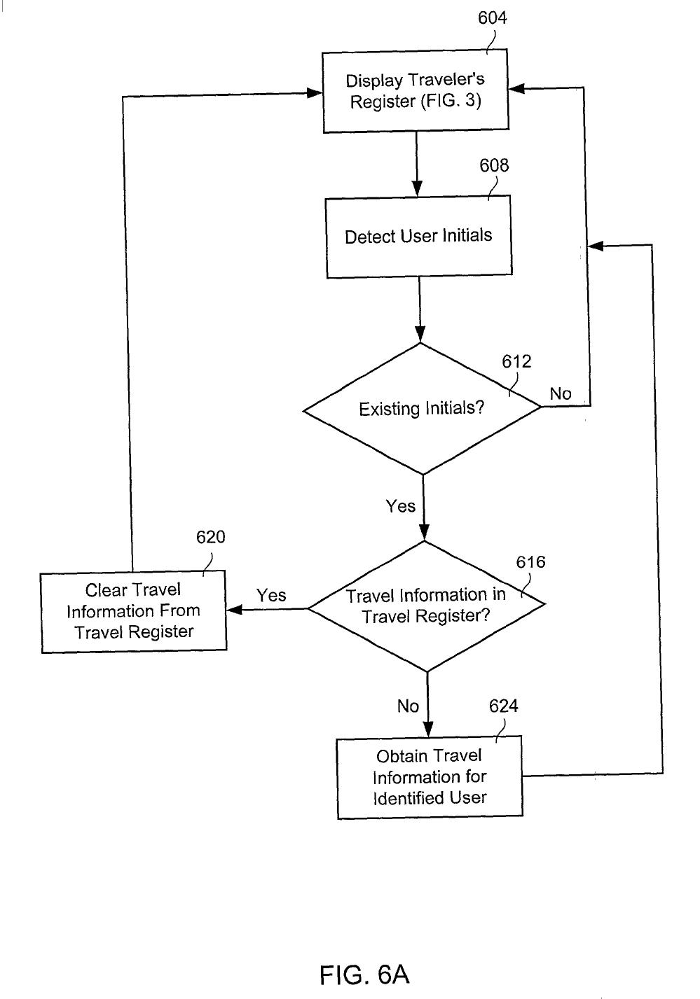

Addition of a new user may proceed similarly, with the system configured to respond to entry of a character such as “N” along the path that proceeds directly to step 432 to request both user initials and a surname. Alternatively, the system may be configured to respond to any set of characters as potentially defining initials for a new user. In this embodiment, where a set of characters is entered that does not have an otherwise predetermined function, the system checks at step 444 to determine whether the characters correspond to an existing set of initials within the system. If so, the method proceeds to perform operations on the short-term-absence register at step 448, and as described below with reference to FIG. 5A. If the initials are new, however, the system proceeds to step 432 to request a surname, filling in the user initials automatically from the detected entry.

An example of a screen requesting entry of an employee's initials and surname is shown in FIG. 4B. An initials field 460 and a surname filed 464 are provided to collect the desired information, with an “Add” button 468 and a “Cancel” button 472 so that a decision can be made to add the new user or not. The screen shown in FIG. 4A provides an example where the system automatically completed the initials field 460 because an unknown set of characters was input from the IO Register. The initials may be modified at this stage; for this reason and because the “Add New User” screen may be reached directly, a check is made at step 436 to ensure that initials that duplicate those of another employee are not to be added. If not, the new employee is added at step 440 and a modified IO Register is displayed at step 428. An example of the modified IO Register is shown in FIG. 4C, which differs from FIG. 2A by the presence of “Carmichael,” with initials “ABC.”

When the initials of an existing employee are entered in the entry field 224 of the IO register, availability information for the short-term-absence register may be updated according to the flow diagram shown in FIG. 5A. At step 504, the initials for an existing employee have been detected by the system, so a determination is made at step 508 whether information already exists in the IO Register that that employee is unavailable. If so, such information is cleared at step 512 from the system so that the employee is then identified as available, and the system displays the modified IO Register at step 532. If there is no information existing in the IO Register that the identified employee is unavailable, a prompt is supplied as in FIG. 5B requesting unavailability information. Such a prompt includes a field 536 for entering such information, with a buttons 540 and 544 for confirming or canceling the information. In one embodiment, a single character, such as “T,” may be entered to denote that the employee will be absent the following day. A check is made at step 520 to determine whether that character was entered or whether free-form information was entered. If the tomorrow character was entered, the IO Register is updated at step 528 to add the next-day information automatically and the modified register is displayed at step 532. If free-form information was entered, it is added to the 10 Register at step 524 in the form entered and the modified register is displayed at step 532. An example of such free form information indicating that Carmichael will be unavailable because of a meeting between 3 and 5 PM is shown in FIG. 5C.

The system is thus especially convenient since minimal keystrokes are needed to use it; this simplicity makes the system more likely to be used regularly and increases its value. Thus, for example, when Carmichael is going to his meeting, all he need do to register his unavailability is to type his initials “ABC” followed by his free-form explanation “Meeting 3-5 PM.” When he returns to his office early at 4:30, he need only type his initials “ABC” to register his availability. FIG. 5D shows an example of how the system responds from its state in FIG. 5C to the entry of “ABC” in the 10 Register. If Carmichael were to be absent the following day, simply entering his initials “ABC,” followed by “T” causes his absence to be noted. Depending on which embodiment is implemented, this notation of absence may be removed automatically when he returns two days later or may instead require that he actively log back in to the system upon his return.

The long-term-absence register benefits from a similarly simple interface, as illustrated with the flow diagram shown as FIG. 6A. When the Traveler's Register is displayed at step 604, it is ready to detect the entry of employee initials at step 608. A check is made at step 612 that the employee initials are valid and, if so, a check is made at step 616 whether long-term absence information already exists in the long-term-absence register for that employee. If so, it is cleared at step 620. If not, such information is obtained with a form such as displayed in FIG. 6B, which includes fields for the employee's destination 628, when the employee leaves 632, and when the employee returns 636. Buttons 640 and 644 are provided to confirm or cancel the information entered. An example is shown in FIG. 6C of the resulting Travel Register when Carmichael enters that he will be in Paris from Apr. 23, 2001 until May 9, 2001. Thus, like the short-term-absence register, the availability information in the long-term-absence register is especially easily managed.

The system may also include a number of administrative features. A setup screen reached by entering, for example, “A” in the short-term register is shown in FIG. 7A. Under the header 702 and date field 704, several fields are provided for customization of the system. The name of the organization may be entered in field 706. Whether to display the date and time, as well as the formats for their display may be configured with fields 708 and 710. A color scheme for the displays may be provided with field 712. The system may also be configured with security options, which may be particularly desirable when the system is configured for availability over the internet. A system password may be provided in field 714, an administrative password may be provided in field 716, and a password timeout may be specified in field 718.

The system may also accommodate a number of record options. While the discussion above has used examples where availability was indicated with a null default status, this may be changed by having a default status of “In” or a customized default status with field 720. Whether to include the long-term absence field 238 in the short-term-absence register is defined by field 722, including the symbol to be used. Limitations on the length of names, status, records per page, and rows per column are specified respectively in fields 724, 726, 728, and 730. Finally, the system may include language options, such as provided by fields 732 and 736.

The language field 732 allows any of a number of languages to be used. For example, when the language is changed to one of the predefined languages, such as French, the short-term register appears as in FIG. 7B. All screens are then displayed in French, including the administration display, as shown in FIG. 7C. When the language creation field 736 is activated, a screen is presented as in FIG. 7D to define the name of the language and to select a known base language for translation of the necessary terns. FIG. 7E (shown in parts 7E-1 through 7E-9) shows various fields where the new language to be defined is Esperanto and the parent language selected for translation was selected as English in FIG. 7D. Thus, two columns are provided, one with all terms in the base language of English and fields in which they can be retyped in the new language of Esperanto.

Steps of the method may be embodied as a computer program stored on a computer-readable medium, such as a hard disk drive or a removable disk. The data used by the computer program may similarly be stored on a computer-readable medium. The computer program dictates the execution of the steps as outlined above. The computer program code can be written in any conventional computer-readable programming language. Suitable program code may be entered into a single file, or multiple files, using a conventional text editor. If the entered code text is in a high level language, the code is compiled, and the resultant compiler code is then linked with an object code of precompiled windows library routines. To execute the linked compiled object code, the system user invokes the object code causing the computer system to load the code in memory. The CPU reads the code from memory and executes the code to perform the tasks identified in the program.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for monitoring availability of a plurality of units, the method comprising:
maintaining a list identifying the plurality of units, such list including a notation indicating whether each such unit is unavailable;
accepting an electronic identification of a particular one of the plurality of units;
determining whether the list includes the notation that the particular unit is unavailable;
automatically modifying the list to remove the notation that the particular unit is unavailable if it is determined that the particular unit is unavailable; and
collecting information specifying unavailability of the particular unit if it is determined that the particular unit is not unavailable.

2. The method recited in claim 1 further comprising displaying the list.

3. The method recited in claim 2 further comprising displaying descriptive headings with the list in a language selected by a user.

4. The method recited in claim 1 further comprising displaying only a portion of the list, wherein every unit in the portion includes the notation indicating that such unit is unavailable.

5. The method recited in claim 1 further comprising modifying the list to indicate that the particular unit is unavailable in accordance with the collected information.

6. The method recited in claim 1 wherein the notation includes a time a specific unit will become available, the method further comprising automatically removing the notation for the specific unit when the time passes.

7. The method recited in claim 1 wherein the notation includes a date a specific unit will become available, the method further comprising automatically removing the notation for the specific unit when on that date.

8. The method recited in claim 1 wherein the notation included with the list indicates unavailability of each unit for a period less than a day, the method further comprising maintaining a second list identifying a subset of the plurality of units, the second list including a second notation indicating that each unit in the subset is unavailable for a period greater than a day.

9. The method recited in claim 8 wherein the list further includes a third notation indicating whether each unit in the list has a corresponding entry in the second list.

10. The method recited in claim 1 wherein the plurality of units comprises a plurality of persons.

11. The method recited in claim 10 wherein the plurality of persons comprises a plurality of employees of a business organization.

12. The method recited in claim 1 wherein the plurality of units comprises a plurality of stations.

13. A computer-readable storage medium having a computer-readable program embodied therein for monitoring availability of a plurality of units in accordance with the following:
maintaining a list identifying the plurality of units, such list including a notation indicating whether each such unit is unavailable;
accepting an electronic identification of a particular one of the plurality of units;
determining whether the list includes the notation that the particular unit is unavailable;
modifying the list to remove the notation that the particular unit is unavailable if it is determined that the particular unit is unavailable; and
collecting information specifying unavailability of the particular unit if it is determined that the particular unit is not unavailable.

14. The computer-readable storage medium recited in claim 13 wherein the plurality of units comprises a plurality of employees of a business organization.

15. The computer-readable storage medium recited in claim 13 wherein the plurality of units comprises a plurality of stations.

16. A computer system comprising:
a storage device; and
a processor in communication with an input device, a display device, and the storage device, the processor configured to execute instructions for monitoring the availability of a plurality of units in accordance with the following:
maintaining a list on the storage device identifying the plurality of units, such list including a notation indicating whether each such unit is unavailable;
accepting an identification from the input device of a particular one of the plurality of units;
determining whether the list includes the notation that the particular unit is unavailable;
modifying the list to remove the notation that the particular unit is unavailable if it is determined that the particular unit is unavailable;
collecting information specifying unavailability of the particular unit if it is determined that the particular unit is not unavailable; and
displaying the list on the display device.

17. The computer system recited in claim 16 wherein the processor is in communication with a plurality of input devices and with a plurality of display devices.

18. The computer system recited in claim 17 wherein the processor is configured for communication with the plurality of input devices and for communication with the plurality of display devices through a network.

19. The computer system recited in claim 17 wherein the processor is configured for communication with the plurality of input devices and for communication with the plurality of display devices through the internet.
